(19) United States
(12) Patent Application Publication
(10) Pub. No.: US 2026/0079476 A1
(43) Pub. Date: Mar. 19, 2026

(54) Method for Supporting a Process Change, Computer Program Product and System

(71) Applicant: Windmöller & Hölscher KG, Lengerich (DE)

(72) Inventors: Daniel Niehues, Lengerich (DE); Tobias Kulgemeyer, Lengerich (DE); Till Bergmann, Lengerich (DE)

(21) Appl. No.: 19/109,933

(22) PCT Filed: Sep. 8, 2023
(86) PCT No.: PCT/EP2023/074796

§ 371 Date: Mar. 7, 2025

(30) Foreign Application Priority Data
Sep. 9, 2022 (DE) 10 2022 123 024.4

(51) Int. Cl. G05B 19/418

(52) U.S. Cl. CPC G05B 19/41865; G05B 2219/32135

(57) ABSTRACT

The invention relates to a method (100) for supporting at least one process change from a manufacturing process (200) for manufacturing a first film material (201) to a subsequent process (210) for manufacturing a second film material (211) in an extrusion device (10). The invention also relates to a computer program product and a system (1).

### DESCRIPTION

The invention relates to a method for supporting a process change, a computer program product and a system.

It is generally known that different products can be manufactured using extrusion devices in the form of film machines. The products usually differ from one another due to their different recipes. This means that a series of different orders with different recipes are processed sequentially one after the other. For the transition between two recipes, a change is made from a recipe currently in use to a subsequent recipe. In known solutions, this change is usually carried out manually and based on the experience of the machine operator.

The disadvantage of such solutions is that the quality and, above all, the time required to implement the change from one recipe to the next is based solely on the knowledge of the machine operator. This means that a very high rejection rate can be achieved for this change between recipes, particularly with inexperienced machine operators. In particular, it is not possible to achieve a clear and continuous quality requirement for all changes to subsequent recipes in this way. Last but not least, the possibility of errors cannot be ruled out.

It is therefore known from DE 10 2015 108 974 A1 to predetermine a process limitation in the form of an end of a production order and to specify a reduced changeover filling level in anticipation of this end of the production order. This can reduce material waste due to excess material during the process change. However, it is desirable to further reduce material waste.

It is an object of the present invention to at least partially eliminate the above disadvantages known from the prior art. In particular, it is an object of the present invention to improve a process change of an extrusion device in order to shorten a required change time and/or to reduce a material waste during the process change.

The above problem is solved by a method having the features of claim 1, a computer program product having the features of claim 17, and a system having the features of claim 18. Further features and details of the invention are apparent from the respective dependent claims, the description and the drawings. Features and details which are described in connection with the method according to the invention naturally also apply in connection with the computer program product according to the invention and/or the system according to the invention and vice versa, so that reference is or can always be made to the individual aspects of the invention with respect to the disclosure.

According to a first aspect of the invention, there is provided a method for supporting at least one process change from a manufacturing process for manufacturing a first film material to a subsequent process for manufacturing a second film material in an extrusion device. The method comprises, in particular in the form of method stages/steps:
controlling of the extrusion device for implementing the manufacturing process with at least one process parameter set, in particular by a control system,
detecting of at least one set of setpoint subsequent parameters of the subsequent process assigned to the process parameter set, in particular by the control system,
planning a preparatory operation for preparing the subsequent process with at least one preparatory measure for at least partial or complete adjustment of the process parameter set depending on the assigned setpoint subsequent parameter set, in particular by the control system,
implementing the preparatory measure during the manufacturing process to prepare the process change from the manufacturing process to the subsequent process, in particular through the control system.

The extrusion device can advantageously be a film machine, in particular a cast film machine and/or a blown film machine. The extrusion device may comprise one or more extruders for heating, mixing and/or conveying raw material.

Preferably, the first and second film materials are each in the form of a plastic film. The first film material and the second film material can preferably differ in a formulation, i.e. in particular in a material composition, and/or in a format. For example, different raw materials and/or different quantity proportions of raw materials can be used for the first and second film materials. The format can preferably be understood as a geometric configuration, such as a film width and/or film thickness, of the first and second film material. A production result of the manufacturing process can comprise a first film product, e.g. a tubular and/or flat film, and a production result of the subsequent process can comprise a second film product, e.g. a tubular and/or flat film. The first and second film products can each be produced and/or processed in individual film sections or as a continuous product.

The manufacturing process and the subsequent process can each comprise a manufacturing job. The process change can preferably take place without stopping the extrusion device, so that the manufacturing process and the subsequent process merge into one another and/or film material is permanently produced. The manufacturing process is understood in particular to mean a good production of the first film material, i.e. a production of the first film material which satisfies at least one quality criterion for the first film material, in particular for the sale of the first film material. The subsequent process is understood in particular to be a good production of the second film material, i.e. a production of the second film material that satisfies at least one quality criterion for the second film material, in particular for the sale of the second film material. Between the manufacturing process and the subsequent process, a changeover process can be carried out in which only material waste is produced which satisfies neither the quality criterion for the first film material nor the quality criterion for the second film material. The changeover process is preferably minimized by the method according to the invention.

The process parameter set can comprise one or more process parameters of actual machine data and/or target machine data of the extrusion device, in particular in the form of sensor data and/or control and/or regulation data, of the manufacturing process. For example, the process parameter sets may comprise temperature data of the extrusion device and/or material conveying data of the extrusion device, in particular in the form of a conveying speed and/or an extruder rotational speed. It may be provided that the process parameter set is to continuously or discontinuously control and/or regulate the extrusion device when the extrusion device is controlled during the manufacturing process. For this purpose, the process parameter set can be transmitted from the control system to the extrusion device, in particular to components of the extrusion device.

The setpoint subsequent parameter set can comprise one or more subsequent process parameters of set machine data of the extrusion device, in particular in the form of control and/or regulation data, for the subsequent process. In particular, the setpoint subsequent parameter set may comprise temperature data of the extrusion device and/or material conveying data of the extrusion device, in particular in the form of a conveying speed and/or an extruder rotational speed. Thus, the setpoint subsequent parameter set may comprise one or more subsequent process parameters which are assigned to the one or more process parameters of the process parameter set, but which relate to the subsequent process. When the setpoint subsequent parameter set is detected, the setpoint subsequent parameter set can, for example, be retrieved from a memory device and/or from a database. However, it is also conceivable that the setpoint subsequent parameter set is captured by a user input, in particular on the extrusion device.

The preparatory operation can comprise a time sequence of the manufacturing process, in particular the control of the extrusion device up to a process completion of the manufacturing process. It can be determined for at least one process parameter, preferably for each process parameter, of the process parameter set whether and/or when the at least partial adjustment to the respectively assigned subsequent parameter of the subsequent parameter set takes place. However, it is also conceivable that only the, in particular next, preparatory operation is defined when planning the preparatory measure. In this case, the planning of the preparatory operation can preferably be repeated after the preparatory measure has been implemented. The adjustment of the process parameter set can comprise an at least partial or complete equalisation of one or more, preferably all, process parameters of the process parameter set to the respectively assigned subsequent process parameters of the setpoint subsequent parameter set. Preferably, an influence of the adjustment on the manufacturing process is evaluated during the preparatory operation and the preparatory measure is determined dependent on the influence of the adjustment on the manufacturing process. For example, the adjustment can be varied in order to optimize the preparatory operation, in particular with regard to the influence of the adjustment on the manufacturing process. Preferably, the planning of the preparatory operation is carried out depending on a target variable, in particular a target variable to be optimized, in particular wherein the target variable comprises a material quantity, a changeover time of the process changeover, a quality criterion for the first film material and/or the second film material and/or a process reliability when implementing the process changeover. The material quantity can refer to a material ingredient, i.e. in particular a raw material, for the first and/or second film material. However, it is also conceivable that the target variable comprises a material quantity of a film material produced by the extrusion device, i.e. in particular a starting material.

The preparatory measure is preferably determined during the preparatory operation and/or carried out automatically depending on the planned preparatory operation. In particular, the preparatory measure is implemented during the manufacturing process, i.e. before the process change and/or the process completion of the manufacturing process. The preparatory measure can be configured to automatically execute and/or support the at least partial adjustment of the process parameter set to the setpoint subsequent parameter set. It is conceivable that the preparatory measure comprises an output of one or more recommended actions for at least partial adjustment of the process parameter set to the assigned setpoint subsequent parameter set.

It has been recognized in the context of the invention that certain measures for preparing the subsequent process can already be taken during the manufacturing process, i.e. before a process completion of the manufacturing process, without affecting the manufacturing process. For example, it may be envisaged that an increased temperature of a component of the extrusion device is required in the subsequent process in order to produce the second film material, but that an increase in temperature, in particular within a certain range, still results in a desired film quality of the first film material. Thus, suitable process parameters for adjustment during the manufacturing process can be identified during the preparatory operation. The extrusion device can be permanently controlled to implement the manufacturing process. Therefore, the planning of the preparatory operation and the implementation of the preparatory measure is carried out in particular during the manufacturing process. As a result, a process boundary between the manufacturing process and the subsequent process is diluted and/or partially shifted into the manufacturing process. If the preparation is thus already carried out at least in part during the ongoing manufacturing process in which the first film material is still being produced, material waste during the process change can be reduced accordingly and/or a changeover time during the process change can be shortened.

It is also conceivable in a method according to the invention that a limiting parameter set for limiting the adjustment of the process parameter set is identified when planning the preparatory operation for the process parameter set of the manufacturing process. The limiting parameter set can, for example, be defined using a quality criterion for the first film material. Preferably, a limiting parameter and/or a limiting range can be defined for each process parameter. The limiting parameter set can be identified when planning the preparatory operation. For example, the limiting parameter set can be provided and/or retrieved from a memory device. However, it is also conceivable that the limiting parameter set is calculated, e.g. using a calculation model for the extrusion device and/or the manufacturing process. The limiting parameter set can be used to ensure that the adjustment of the process parameter set defined during the planning of the preparatory operation has little or no effect on the film quality of the first film material during the manufacturing process.

Furthermore, in a method according to the invention, it is conceivable that the process parameter set comprises temperature data of the extrusion device and/or material conveying data of the extrusion device, in particular in the form of a conveying speed and/or an extruder rotational speed, the adjustment of which is determined during the preparatory operation. The setting of a certain process temperature for the subsequent process generally requires a certain lead time in order to heat up a component of the extrusion device, such as a film blowing head. For example, a speed of a temperature adjustment can be operated at less than or equal to 20° C. per hour. At the same time, the manufacturing process can be insensitive to a few degrees difference in process temperature, so that good production is still possible during heating. By shifting the heating process to the manufacturing process, the process boundary between the manufacturing process and the subsequent process can therefore become blurred. The adjustment of material conveying data can have a positive effect on bubble stability, for example, if the manufacturing process is a blown film extrusion. The material conveying data can therefore compensate for any negative effects of adjusting another process parameter. Furthermore, a rinsing operation of one or more extruders of the extrusion device can be prepared by adjusting the material conveying data.

In the context of the invention, it is also conceivable that, when planning the preparatory operation, a process completion of the manufacturing process is precalculated depending on the process parameter set, in particular with the implementation of the preparatory measure taking place at a time depending on the process completion. The process completion can be understood as a point, in particular a point in time, for the manufacturing process from which good production of the first film material is completed. After process completion, the changeover process and/or the subsequent process can begin. Order data of the manufacturing process can be taken into account for the precalculation of the process completion. Furthermore, a quantity of the first film material already produced by the manufacturing process can be determined to precalculating the process completion. By precalculating the process completion, the timing for the adjustment can be improved. For example, a time for the preparatory measure can be specified so that completion of the adjustment of the process parameter set coincides with the process completion in terms of time and/or material consumption.

Furthermore, in a method according to the invention, it is conceivable that the method comprises, in particular in the form of a method stage:
determining a process target of the manufacturing process for manufacturing the first film material, in particular by the control system,
whereby the process completion is precalculated depending on the process target and the at least partial adjustment of the process parameter set. The process target may, for example, comprise a quantity of the first film material to be produced. Furthermore, the process target may have a correlation to one or more quality criteria of the first film material and/or a process stability of the manufacturing process. Thus, it is conceivable that the process target comprises a specific quantity of a first film quality and a specific quantity of a second film quality of the first film material. The quantity of the first film material can, for example, be specified in weight and/or in wraps produced. Preferably, material data of the manufacturing process for manufacturing the first film is captured to detect the process parameter set. The material data can comprise input data of a raw material and/or output data of a produced quantity of the first film material. Furthermore, the material data may comprise a material type, a material composition, in particular with percentage proportions of material ingredients, and/or material properties, such as a viscosity of the material ingredients. In particular, the material ingredients can be understood as raw materials of the manufacturing process. When comparing the process parameter set with the setpoint subsequent parameter set, the process completion can be precalculated on an order-related basis. The outstanding course of the manufacturing process can thus be included in the precalculation of the process completion with the adjustment of the process parameter set.

Furthermore, it is conceivable within the scope of the invention that a material flow within the extrusion device for the process change is identified depending on the process parameter set and the target process parameter set, wherein the planning of the preparatory operation is carried out depending on the material flow. When identifying the material flow, the material flow can advantageously be calculated and/or determined empirically, in particular analytically and/or numerically. For example, it is conceivable that an observed material flow is extrapolated over a certain period of time. To identify the material flow, the process parameter set and the target process parameter set can be used to provide information about boundary conditions and/or material ingredients. For example, the process parameter set and the target process parameter set can be used to determine whether certain actions, such as a rinsing operation, are required for the process change in order to set up the subsequent process based on the target process parameter set. These actions can determine the material flow, e.g. of a rinsing material. It is also conceivable that the process parameter set can be used to determine material data, in particular to map the material behavior of at least one first material ingredient used in the manufacturing process, and the target process parameter set can be used to determine subsequent material data, in particular to map the material behavior of at least one second material ingredient used in the subsequent process instead of the first material ingredient. In this way, the material course can be simulated in particular in order to calculate the achievement of the process target at least partially in advance. As a result, the comparative data and/or the recommended action can be improved.

In the context of the invention, it is further conceivable that the preparatory measure comprises an automatic control of the extrusion device for carrying out the at least partial adjustment of the process parameter set during the manufacturing process, i.e. in particular before the process completion. During automatic control in dependence on the preparatory operation, a signal for controlling and/or regulating the extrusion device for the manufacturing process can be sent to the extrusion device by the control system. The control signal can comprise the adjustment of the process parameter set, in particular in the form of target process parameters and/or target process parameter sequences. The automatic control can achieve a high level of precision when adjusting the process parameter set. In addition, an operator can be freed up in terms of time, which the operator can use to carry out further preparatory measures, such as material procurement.

It is also conceivable in a method according to the invention that, in preparation for the process completion, i.e. in particular during the manufacturing process and/or before and/or with the implementation of the preparatory measure, an automatic modification of a material inflow to at least one extruder and/or a feed device of the extrusion device is carried out, in particular depending on the process completion. When modifying the material inflow, a material inflow of a first material ingredient of the manufacturing process can be reduced, so that at the process completion no or only a reduced quantity of the first material ingredient is present in the extrusion device. Preferably, when modifying the material inflow, the material inflow of the first material ingredient of the manufacturing process can be interrupted and/or a material inflow of a second material ingredient of the subsequent process can be activated. Modifying the material inflow can result in only the material still in the extruder and/or in the feed device being consumed in order to reduce material waste during the process change

Furthermore, in a method according to the invention, it can advantageously be provided that a balancing, preferably external or internal, of a produced quantity of the first film material and/or a quantity of a material ingredient introduced into the extrusion device is carried out, in particular wherein the preparatory operation and/or the calculation of the process completion is carried out depending on the balancing. The balancing can be carried out for the part of the manufacturing process that has already been carried out. In particular, the manufacturing process can be divided into several process phases, for each of which the balancing is performed separately. For example, the process phases can include a start phase for starting the manufacturing process, a good production, a bad production and/or phases of different film qualities. In particular, the quantity of the first film material and/or the introduced material ingredient can be measured for balancing. The quantity of the first film material and/or the introduced material ingredient may comprise a weight. The quantity of the first film material may further be performed by identifying the linear meters of the first film material produced, an area of the first film material produced, and/or a number of wraps produced. The quantity of material ingredient introduced may, for example, be measured in and/or upstream of one or more extruders of the extrusion device. However, it is also conceivable that the balancing is carried out on the basis of one or more user inputs. For this purpose, a prompt can be output to the user during the preparatory operation.

Within the scope of the invention, it is also conceivable that, for the balancing, an evaluation of material sections of the produced first film material is carried out with regard to a quality criterion of the first film material and, in order to predict the fulfillment of the process target, it is checked which of the material sections fulfill the quality criterion. The material sections can be related to different phases of the manufacturing process. For example, the phases of the manufacturing process can include an initialization process of the manufacturing process, e.g. in the form of a start-up of the extrusion device and/or a good production. Furthermore, the material sections can be divided into batches of the first film material. To evaluate the quality criterion, a film quality of the first film material can preferably be measured. The quality criterion may comprise, for example, a relaxation size, a film thickness, a print quality of an imprint on the first film material and/or a transparency of the produced first film material. Furthermore, local deviations from the quality criterion in the form of irregularities in the manufacturing process and/or in the first film material can be detected during the evaluation of the material sections. The irregularities can be eliminated during the balancing process. By evaluating the material sections, it can thus be ensured that only material sections that meet the quality criterion are included in the balancing. As a result, a differentiated overview of the quantity of the first film material produced can be obtained in order to fulfill the process target and plan the preparatory operation.

Preferably, in a method according to the invention, it can advantageously be provided that, preferably for planning the preparatory operation and/or for determining the preparatory measure, a process inflection point is determined on the basis of the balancing and/or on the basis of the process completion, from which a continuation of the manufacturing process is no longer possible while maintaining a quality criterion and/or a process stability criterion of the first film material. The quality criterion can be the quality criterion of the material sections. Preferably, after the process inflection point, the process change to the subsequent process is forced, in particular electronically. For example, an extension of the manufacturing process can be initiated automatically and/or by an operator before the process inflection point and/or prevented, in particular electronically, after the process inflection point. The process inflection point can be output as information for an operator. In particular, the process inflection point can prevent a bad production from occurring unnoticed, e.g. due to manual user interaction during the manufacturing process, which then changes back into a good production due to a subsequent extension of the manufacturing process. It is also possible that an operator is expected to confirm the process inflection point before the preparatory measure is implemented. This can prevent the process inflection point from being reached without the consent of the operator, in particular through the preparatory measure.

Within the scope of the invention, it is further conceivable that the method comprises:
capturing of sensor data to detect a modification in the manufacturing process that occurs depending on the preparatory measure, in particular by the control system,
wherein the sensor data is monitored with respect to a process condition of the manufacturing process, in particular wherein the process condition comprises the quality criterion of the first film material and/or a process stability criterion of the manufacturing process. Preferably, the preparatory measure is interrupted and/or a countermeasure is carried out if it is determined on the basis of the sensor data that the process condition is not fulfilled. The sensor data can include, for example, motor current values of an electric motor, temperature values and/or a temperature course on a component of the extrusion device and/or the like. This can be used to recognize at any time how far the process change has been implemented on the extrusion device. Furthermore, the sensor data can comprise image data from a camera, in particular for detecting a bubble shape. For example, the process condition can include maintaining a bubble shape in order to prevent film breakage and thus an interruption to the manufacturing process. The sensor data can thus be used for monitoring in order to be able to control the influence of the preparatory measure on the manufacturing process.

Preferably, in a method according to the invention, it may be provided that the method comprises:
determining the subsequent process using a process collection for the manufacturing of different film materials by analyzing the process collection using the process parameter set of the manufacturing process with regard to the at least partial adjustment of the process parameter set.

In particular, a target variable for determining the subsequent process can be defined in the form of a material consumption to be minimized, a process changeover time to be minimized, a quality criterion of the first and/or second film material and/or a process stability criterion. It is conceivable that several target variables are taken into account when determining the subsequent process. The process collection can include several planned manufacturing processes, for example in the form of an order list of film materials to be produced. By determining the subsequent process, the subsequent process can be determined automatically from the planned manufacturing processes in order to match the subsequent process to the current manufacturing process. This can simplify the process change. When analyzing the process collection, the process parameter set of the current manufacturing process can be compared with the parameter sets of the planned manufacturing processes. For example, the recipes of the planned manufacturing processes can be checked for similarity to the recipe of the current manufacturing process during the prioritization process. Furthermore, the process collection can be sorted to determine the subsequent process in order to define a sequence of manufacturing processes. Determining the subsequent process using the process collection can reduce material waste and/or the complexity of the process change for the operator during the process change, especially if the greatest possible similarity between the manufacturing process and the subsequent process is achieved.

Within the scope of the invention, it is also conceivable that reference data of at least one reference change and/or a process history of previous manufacturing processes are provided for the current manufacturing process, with the planning of the preparatory operation and/or the calculation of the process completion being carried out depending on the reference data. In particular, the reference change can be a recorded process change, especially in which the same or similar recipes were present compared to the current process change. For example, the reference change can be carried out manually by an experienced operator, such as a lead operator, for recording. This allows other operators, who have less experience for the process change, to be guided by the reference change to perform the process change. Preferably, the control system can have artificial intelligence, in particular in the form of an artificial neural network. The reference data can form training data for the artificial intelligence. Preferably, the process parameter set and the setpoint subsequent parameter set can be fed to the artificial intelligence as input data in order to obtain the planning of the preparatory operation and/or the preparatory measure as output data. The reference data can be used to provide an advantageous starting point for the preparatory operation, allowing individual experience in the operation of the extrusion device and/or in the implementation of different film formulations to be incorporated into the preparatory operation. This allows special know-how to be taken into account in the method.

Furthermore, in a method according to the invention, it may advantageously be provided that implementation data of the preparatory measure, in particular depending on the sensor data, is stored as part of the process history for provision for further subsequent processes. The implementation data can comprise the material data, the process parameter set, the setpoint subsequent parameter set, the at least one quality criterion and/or further process data. In this way, the preparatory measure and/or the current process change can be incorporated into the database available to the control system, thereby improving the know-how of the operation of the extrusion device especially. In particular, if the sensor data is stored with the implementation data, a system reaction to the preparatory measure can also be recognized and evaluated. In particular, the evaluation can be stored using the sensor data with the implementation data. The method can therefore be configured to be self-learning

Preferably, in a method according to the invention, it can be provided that an artificial intelligence is provided, to which the process parameter set and the setpoint subsequent parameter set, and preferably the process target, are supplied as input data in order to obtain the planning of the preparatory operation and/or the preparatory measure as output data, and/or that the implementation data and/or the process history with the sensor data, the process parameter set and the setpoint subsequent parameter set, and preferably the process target, are supplied to the artificial intelligence as training data, in particular in order to supply the artificial intelligence with the input data for further subsequent processes and to obtain the output data. Additionally or alternatively, it is conceivable that the preparatory operation is fed to the artificial intelligence as input data in order to obtain the preparatory measure as output data. Preferably, the control system, in particular a monitoring device of the control system, may comprise the artificial intelligence, in particular in the form of an artificial neural network. The artificial intelligence can be used to create a self-learning system. Furthermore, large quantity of data can be processed by the artificial intelligence in order to optimize the process change.

According to a further aspect of the invention, there is provided a computer program product comprising instructions which, when executed by a control system, cause the control system to execute a method according to the invention.

Thus, a computer program product according to the invention has the same advantages as those already described in detail with reference to a method according to the invention. In particular, the method may be a computer-implemented method. The computer program product may be implemented as a computer-readable instruction code. Further, the computer program product may be stored on a computer-readable storage medium such as a data disk, a removable drive, a volatile or non-volatile memory, or a built-in memory/processor. Furthermore, the computer program product can be provided or made available on a network, such as the Internet, from which it can be downloaded or executed online by a user as required. The computer program product can be realized through software as well as through one or more special electronic circuits, i.e. in hardware or in any hybrid form, i.e. through software components and hardware components.

According to a further aspect of the invention, a system for guiding a user is provided. The system comprises an extrusion device for implementing a manufacturing process for manufacturing a first film material. Further, the system comprises a control system for implementing a method according to the invention.

Thus, a system according to the invention has the same advantages as those already described in detail with reference to a method according to the invention and/or a computer program product according to the invention. The control system may preferably comprise a monitoring device, in particular comprising a processor and/or microprocessor, for executing the method. Furthermore, the monitoring device can be integrated into a control device of the extrusion device and/or into a control center. The control center can comprise a server and/or a cloud. It is also conceivable that the control system has several, in particular distributed, monitoring devices for executing the method. Furthermore, the control system can comprise a memory device and/or a database for providing the setpoint subsequent parameter set. The system may further comprise a display device for displaying information. For example, the display device may comprise a display and/or a touch screen. Advantageously, the display device can be integrated into the extrusion device and/or the control station. It is also conceivable that the display device is a mobile terminal device, such as a smartphone or a pager.

Further advantages, features and details of the invention are apparent from the following description, in which embodiments of the invention are described in detail with reference to the drawings. The features mentioned in the claims and in the description may be essential to the invention individually or in any combination. It shows schematically:

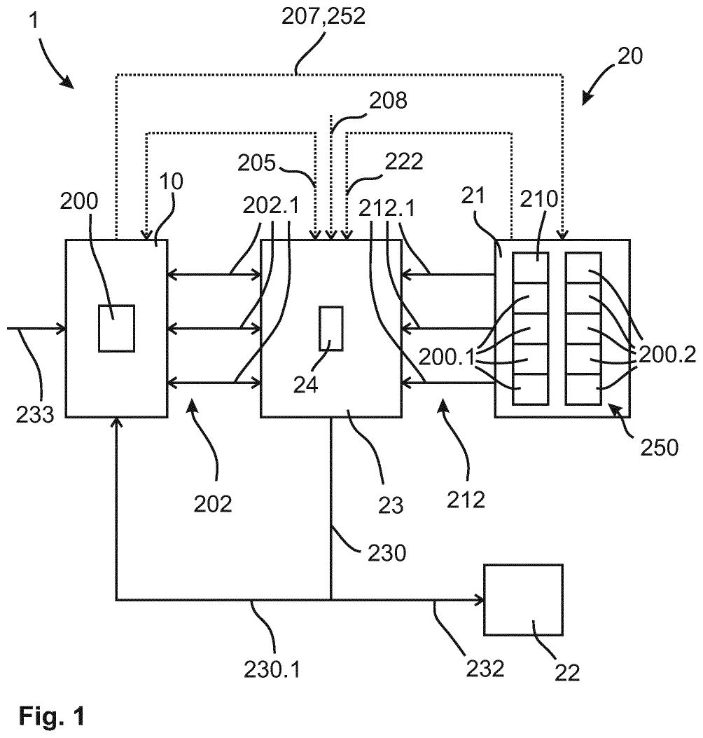

FIG. 1 a system according to the invention when carrying out a method according to the invention,

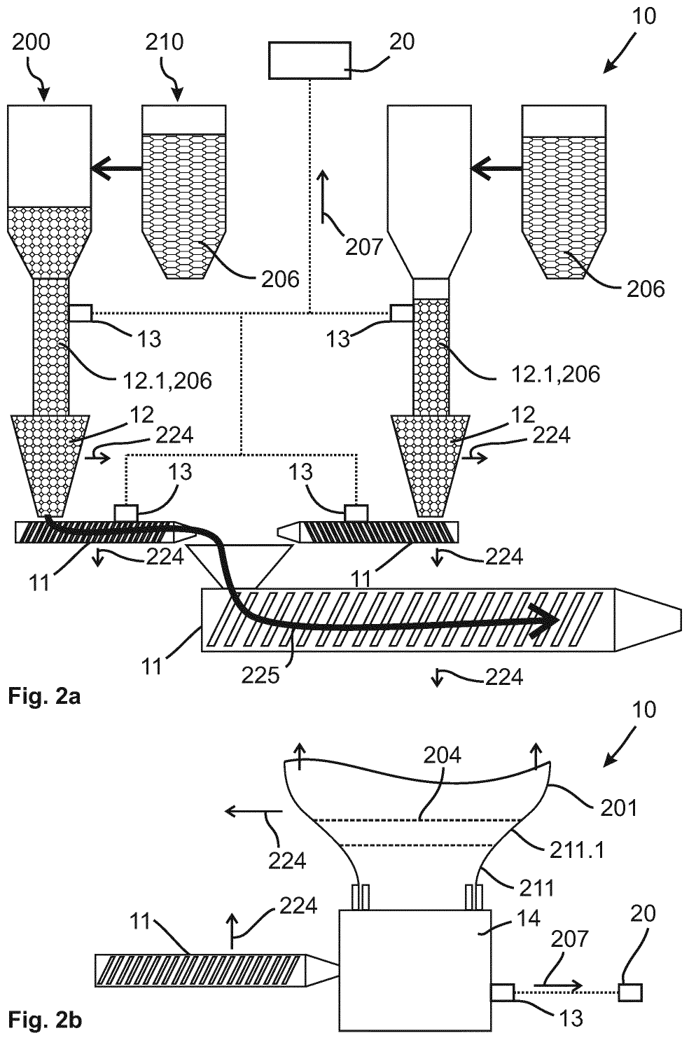

FIGS. 2a & 2b parts of an extrusion device of the system during a process change,

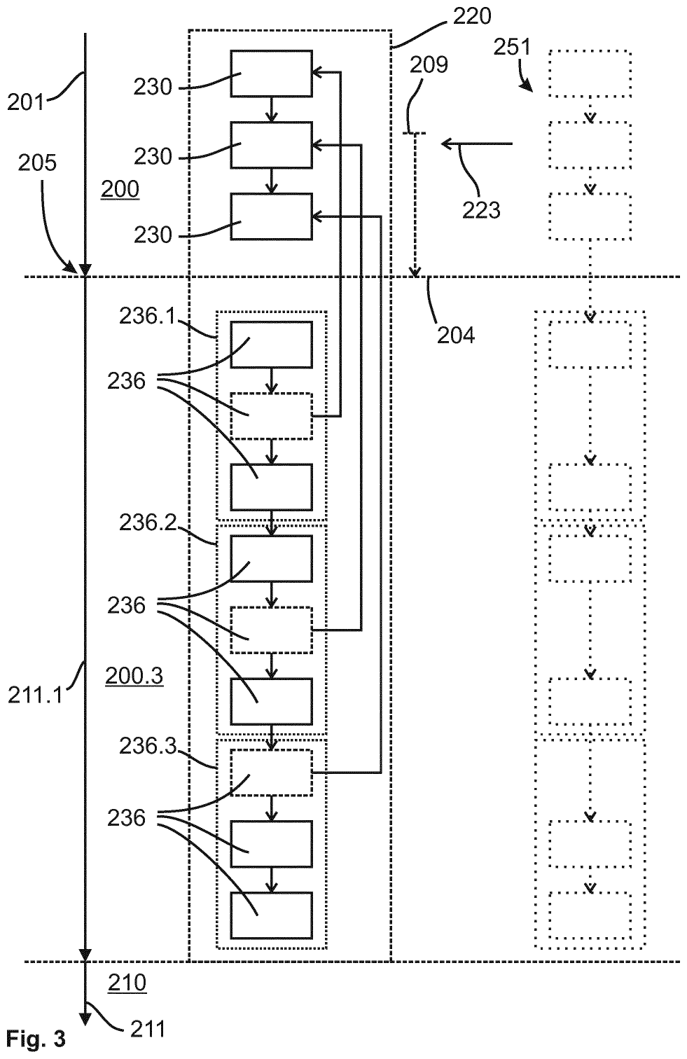

FIG. 3 a process course during the process change, and

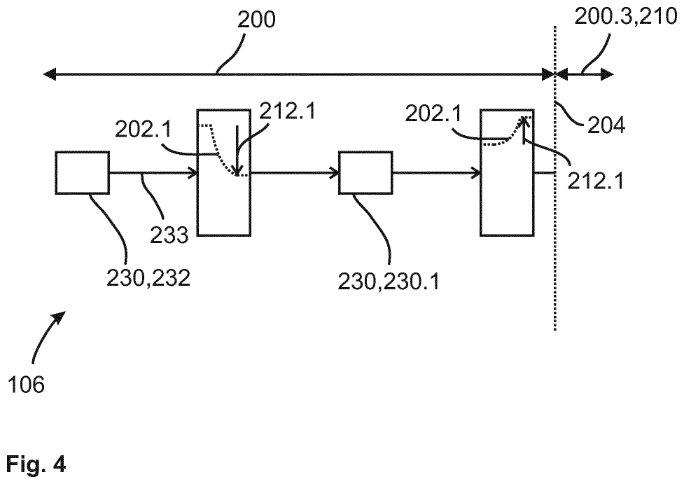

FIG. 4 execution of preparatory measures for the process change, and

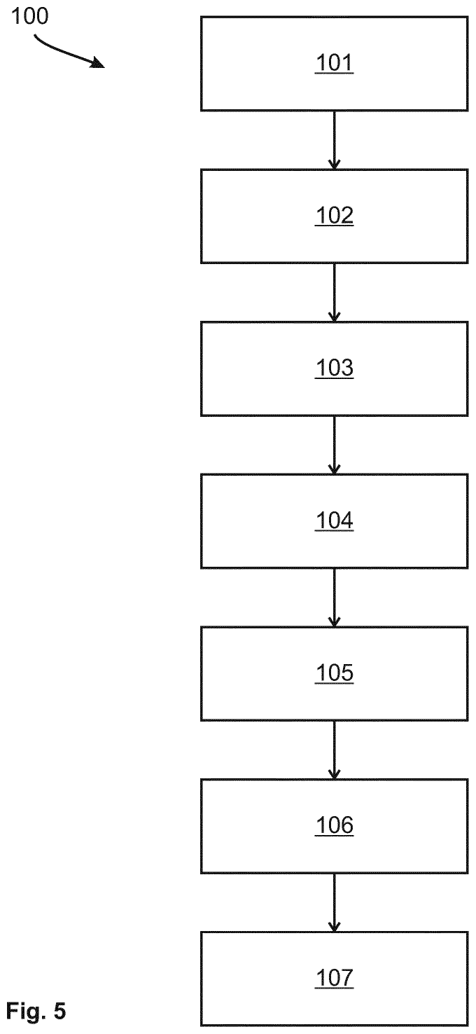

FIG. 5 the method in schematic representation of the method stages.

In the following description of some embodiments of the invention, the identical reference signs are used for the same technical features even in different embodiments.

FIG. 1 shows a system 1 according to the invention with an extrusion device 10 when carrying out a method 100 according to the invention for supporting at least one process change from a manufacturing process 200 for manufacturing a first film material 201 to a subsequent process 210 for manufacturing a second film material 211 in a first embodiment. The manufacturing process 200 for manufacturing a first film material 201 is implemented by the extrusion device 10. As shown in FIGS. 2a and 2b, the extrusion device 10 comprises a plurality of extruders 11 for extruding a plastic material. Furthermore, the extrusion device 10 has a plurality of feed devices 12 through which the extruders 11 are fed with different material ingredients 206. As shown in FIG. 2b, the extrusion device 10 in the present embodiment is a blown film machine with a film blowing head 14 for producing a film bubble, in the region of which the first film material 201 cools. However, it is also conceivable that the extrusion device 10 of system 1 is a cast film machine, for example.

When an order for the production of the first film material 201 is completed, the process change from the manufacturing process 200 of the first film material 201 to the subsequent process 210 of the second film material 211 takes place without stopping the extrusion device 10. As shown in FIG. 2b, the process change can comprise a transition from the first film material 201 to the second film material 211. The transition may, for example, be generated stagelessly and/or by performing an intermediate process 200.3 to generate an intermediate material 211.1 in order to simplify and/or enable the process change. To support the process change from the manufacturing process 200 to the subsequent process 210, the system 1 comprises a control system 20, in particular comprising a monitoring device 23 in the form of a processor and/or microprocessor, for implementing the method 100. Preferably, a computer program product may be provided comprising instructions which, when executed by the control system 20, cause the control system 20 to execute the method 100. Method stages of the method 100 are shown schematically in FIG. 5.

In order to implement the manufacturing process 200, the method 100 first controls 101 the extrusion device 10 with at least one process parameter set 202. The process parameter set 202 comprises in particular one or more process parameters 202.1 of actual machine data and/or target machine data of the extrusion device 10, in particular in the form of sensor data 207 and/or control and/or regulation data, for the manufacturing process 200. The process parameter set 202 can in particular be defined at least partially on the basis of a recipe for the first film material 201. Preferably, a current status of the extrusion device 10 and the manufacturing process 200 is mapped by the process parameter set 202. When controlling 101 the extrusion device 10, the first film material 201 can be produced at least in sections. Furthermore, the method 100 comprises a detection 103 of at least one setpoint subsequent parameter set 212 of the subsequent process 210 associated with the process parameter set 202. The setpoint subsequent parameter set 212 comprises in particular one or more subsequent process parameters 212.1 of setpoint machine data of the extrusion device 10, in particular in the form of control and/or regulation data, for the subsequent process 210. The process parameter set 202 can in particular be defined on the basis of a recipe for the second film material 211 and/or can be retrieved from a memory device 21 of the control system 20 when the setpoint subsequent parameter set 212 is detected 103.

It may be provided that several orders are present in a process collection 240 for the manufacturing of different film materials, which are to be processed after the production of the first film material 201. In order to configure the process change as efficiently as possible, a determination 102 of the subsequent process 210 can preferably first be carried out using the process collection 240, in that an analysis of the process collection 240 is carried out using the process parameter set 202 of the manufacturing process 200 with regard to an at least partial adjustment of the process parameter set 202 during the process change. The analysis may, for example, determine which of the manufacturing processes 210.1 planed according to the process collection 240 requires the least adjustment and/or has the highest compliance with the current manufacturing process 200.

Depending on the associated setpoint subsequent parameter set 212, the method 100 further planning 105 a preparatory operation 220 for preparing the subsequent process 210 for at least partially adjusting the process parameter set 202. The preparatory operation 220 is shown in FIG. 3 and comprises at least one preparatory measure 230 for at least partially adjusting the process parameter set 202. Here, the planning 105 of the preparatory operation 220 extends from a part of the manufacturing process 200 to the start of the subsequent process 210. Various manual and/or automatic changing actions 236 are to be performed in order to carry out the process change. The preparatory measure 230 may comprise, for example, at least one or more changing actions 236 for a rinsing operation 236.1, an adjustment 236.2 of a process parameter 202.1 in the form of a temperature of the extrusion device 10 and/or a modification 236.3 of the process parameter set 202 for maintaining a bubble stability of a film bubble, in particular during the adjustment of the temperature. Furthermore, it is conceivable that the preparatory measure 230 comprises a modification of a material supply 12.1 and/or a start process for the intermediate process 200.3.

Thus, it has been recognized within the scope of the invention that some changing action 236 may be performed and/or prepared prior to completion of the manufacturing process 200. To this end, at least one preparatory measure 230 for executing the preparatory operation 220 for the process change can be defined when planning 105 the preparatory operation 220. In particular, the process parameter set 202 can be at least partially adapted to the associated setpoint subsequent parameter set 212. It is thus conceivable that the process parameter set 202 comprises temperature data of the extrusion device 10 and/or material conveying data of the extrusion device 10, in particular in the form of a conveying speed and/or an extruder rotational speed, the adjustment of which is defined during the preparatory operation 220. In particular, use is made of the fact that the manufacture of film products and the implementation of formulations for the film products basically takes place within the framework of tolerances and/or depending on interrelationships of the process parameters 202.1. Therefore, the first film material 201 can continue to be produced even if individual process parameters 202.1 are already modified. Therefore, when planning 105 the preparatory operation 220 for the process parameter set 202 of the manufacturing process 200, a limiting parameter set 222 is preferably identified for limiting the adjustment to the setpoint subsequent parameter set 212. The limiting parameter set 222 can, for example, be taken from predetermined process data of the manufacturing process 200.

Furthermore, when planning 105 the preparatory operation 220, a process completion 204 of the manufacturing process 200 is preferably precalculated depending on the process parameter set 202. In this way, for example, it can be identified at what time the adjustment of the process parameter set 202 should be completed in order to start the next phase of the process change and/or the subsequent process 210 after the adjustment. For this purpose, a determination 104 of a process target 205 of the manufacturing process 200 for manufacturing the first film material 201 can be performed first. The process target 205 can be recognized, for example, on the basis of order data for the manufacturing process 200. The process completion 204 can then be precalculated depending on the process target 205 and the at least partial adjustment of the process parameter set 202 to the associated setpoint subsequent parameter set 212. In particular, the process completion 204 can be dynamically adapted to the order-related boundary conditions in the form of the process target 205 and/or the process-related planning of the adjustment of the process parameter set 202.

In order to be able to determine a current status of the manufacturing process 200 and/or to be able to precalculate the process completion 204, the method 100 further comprises a balancing 224 of a produced quantity of the first film material 201 and/or a quantity of a material ingredient 206 introduced into the extrusion device 10. As shown in FIGS. 2a and 2b, material data, in particular weight data, volume data, conveying data and/or the like, can be measured at the extrusion device 10 for this purpose. In particular, the balancing 224 is taken into account when planning 105 the preparatory operation 220 in order to enable timing of the adjustment and/or to define an optimum time for the adjustment. Furthermore, a product-related analysis of the balanced quantity can be realized by evaluating material sections of the produced first film material 201 with respect to a quality criterion of the first film material 201 for the balancing 224 and checking which of the material sections fulfill the quality criterion in order to predict the fulfillment of the process target 205. Further, for planning 105 the preparatory operation 220, a material flow 225 within the extrusion device 10 for the process change may be identified depending on the process parameter set 202 and the setpoint subsequent parameter set 212. For example, the material flow 225 may represent a movement of a material boundary between two consecutive raw materials 206 in the extrusion device 10. As a result, the process change can be at least partially material controlled. In particular, for planning 105 a preparatory operation 220, a process inflection point 209 is determined on the basis of the balancing 224 and/or on the basis of the process completion 204, from which a continuation of the manufacturing process 200 is no longer possible while maintaining a quality criterion of the first film material 201. The process inflection point 209 can be output by the display device 22.

As shown in FIG. 3, reference data 223 of at least one reference change 251 for the current manufacturing process 200 can also be provided. The reference change 251 may be a process change that is or has been performed by an experienced operator, in particular a lead operator. In particular, the reference data 223 may comprise a recording of the reference change 251. Additionally or alternatively, the reference data 223 may comprise a process history 250 of previous manufacturing processes 200, which is retrieved from the memory device 21. The planning 105 of the preparatory operation 220 and/or the calculation of the process completion 204 is carried out depending on the reference data 223

As shown in FIG. 4, depending on the preparatory operation 220, one or more preparatory measures 230 are then implemented 106 in order to prepare the process change from the manufacturing process 200 to the subsequent process 210. The preparatory measure 230 preferably comprises an automatic control 230.1 of the extrusion device 10 to perform the at least partial adjustment of the process parameter set 202 during the manufacturing process 200. Additionally or alternatively, it is conceivable that the preparatory operation 220 requires a user interaction 233 and the preparatory measure 230 comprises an output of a recommended action 232 for implementing the user interaction 233 to an operator, in particular by a display device 22 of the control system 20. The implementation 106 of the preparatory measure 230 is preferably performed in dependence on the process completion 204, in order to enable timing coordinated with the process completion 204. Furthermore, an automatic modification of a material feed to at least one extruder 11 and/or a feed device 12 of the extrusion device 10 can be carried out in preparation for the process completion 204, in particular before the implementation 106 of the preparatory measure 230.

As shown in FIGS. 2a and 2b, after or during the implementation 106 of the preparatory measure 230, sensor data 207 is captured 107 for detecting 103 a modification in the manufacturing process 200 by one or more sensors 13 of the extrusion device 10 that occurs depending on the preparatory measure 230. The sensor data 207 is monitored with respect to a process condition 208 of the manufacturing process 200. The process condition 208 comprises the quality criterion of the first film material 201 and/or a process stability criterion of the manufacturing process 200.

Furthermore, particularly depending on the sensor data 207, implementation data 252 of the preparatory measure 230 is preferably stored in the memory device 22 of the control system 20, in particular as part of the process history 250 for provision for further subsequent processes 210, in order to achieve a learning effect and an improvement of the know-how, in particular in-house know-how, on the basis of the implementation data 252. In particular, the monitoring device 23 may comprise an artificial intelligence 24 to which the process parameter set 202 and the setpoint subsequent parameter set 212 are supplied as input data in order to obtain the planning of the preparatory operation 220 and/or the preparatory measure 230 as output data. Additionally or alternatively, the artificial intelligence 24 may be provided with the implementation data 252 and/or the process history 250 with the sensor data 207, the process parameter set 202 and the setpoint subsequent parameter set 212 of the artificial intelligence 24 as training data.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 System
10 Extrusion device
11 Extruder
12 Feed device
13 Sensor
14 Film blowing head
20 Control system
21 Memory device
22 Display device
23 Monitoring device
100 Method
101 Controlling of 10
102 Determining 210
103 Detecting 202
104 Determining 205
105 Planning from 220
106 Implementing of 230
107 Capturing
200 Manufacturing process
200.1 Planned manufacturing process
200.2 Preceding manufacturing process
200.3 Intermediate process
201 First film material
202 Process parameter set
202.1 Process parameters
204 Process completion
205 Process target
206 Material ingredient
207 Sensor data
208 Process condition
210 Subsequent process
210.1 Planned manufacturing process
211 Second film material
211.1 Intermediate material
212 Setpoint subsequent parameter set
212.1 Subsequent process parameters
220 Preparatory operation
222 Limiting parameter set
223 Reference data
224 Balancing
225 Material flow
230 Preparatory measure
230.1 Controlling
232 Recommended action
233 User interaction
236 Changing action
236.1 Rinsing operation
236.2 Adjustment of a temperature
236.3 Modification of 202 to maintain stability of the film bubble
240 Process collection
250 Process history
251 Reference change
252 Implementation data

1. A Method for supporting at least one process change from a manufacturing process for manufacturing a first film material to a subsequent process for manufacturing a second film material in an extrusion device, comprising:
controlling of the extrusion device for implementing the manufacturing process with at least one process parameter set,
detecting of at least one setpoint subsequent parameter set of the subsequent process assigned to the process parameter set,
planning of a preparatory operation for preparing the subsequent process with at least one preparatory measure for at least partially adjusting the process parameter set depending on the associated setpoint subsequent parameter set,
implementing the preparatory measure during the manufacturing process in order to prepare the process change from the manufacturing process to the subsequent process.

2. The method according to claim 1, wherein
a limiting parameter set for limiting the adjustment of the process parameter set is identified during planning of the preparatory operation for the process parameter set of the manufacturing process.

3. The method according to claim 1, wherein
the process parameter set comprises at least temperature data of the extrusion device and/or material conveying data of the extrusion device, speed the adjustment of which is determined during the preparatory operation.

4. The method according to claim 1, wherein
when planning the preparatory operation, a process completion of the manufacturing process is precalculated depending on the process parameter set.

5. The method according to claim 1, wherein
the method comprises:
determining a process target of the manufacturing process for manufacturing the first film material,
wherein the process completion is precalculated depending on the process target and the at least partial adjustment of the process parameter set.

6. The method according to claim 1, wherein
a material flow within the extrusion device for the process change is identified depending on the process parameter set and the target process parameter set the planning of the preparatory operation being carried out depending on the material flow.

7. The method according to claim 1, wherein
the preparatory measure comprises automatically controlling the extrusion device to perform the at least partial adjustment of the process parameter set during the manufacturing process.

8. The method according to claim 1, wherein
an automatic modification in a material feed at least to at least one extruder or a feed device of the extrusion device is carried out in preparation for the process completion.

9. The method according to claim 1, wherein
a balancing of at least a produced quantity of the first film material or a quantity of a material ingredient introduced into the extrusion device takes place.

10. The method according to claim 1, wherein
an evaluation of material sections of the produced first film material with respect to a quality criterion of the first film material is carried out for the balancing and, in order to predict the fulfillment of the process target, it is checked which of the material sections fulfill the quality criterion.

11. The method according to claim 1, wherein
in order to determine the preparatory measure a process inflection point is determined at least on the basis of the balancing or on the basis of the process completion, from which point it is no longer possible to continue the manufacturing process while maintaining a quality criterion of the first film material.

12. The method according to claim 1, wherein
the method comprises:
capturing sensor data for detecting a modification in the manufacturing process that occurs depending on the preparatory measure,
wherein the sensor data are monitored with respect to a process condition of the manufacturing process.

13. The method according to claim 1, wherein
the method comprises:
determining the subsequent process on the basis of a process collection for manufacturing different film materials by analyzing the process collection on the basis of the process parameter set of the manufacturing process with regard to the at least partial adjustment of the process parameter set.

14. The method according to claim 1, wherein
reference data at least of at least one reference change or a process history of previous manufacturing processes are provided for the current manufacturing process, at least the planning of the preparatory operation and/or the calculation of the process completion being carried out depending on the reference data.

15. The method according to claim 1, wherein
implementation data of the preparatory measure, is stored as part of the process history for provision for further subsequent processes.

16. The method according to claim 1, at least wherein
an artificial intelligence is provided, to which the process parameter set and the setpoint subsequent parameter set are fed as input data in order to obtain the planning of at least the preparatory operation or the preparatory measure as output data, or wherein at least the implementation data or the process history with the sensor data, the process parameter set and the setpoint subsequent parameter set are fed to the artificial intelligence as training data.

17. A computer program product comprising instructions which, when executed by a control system, the control system to execute a method according to claim 1.

18. A System comprising
an extrusion device for implementing a manufacturing process for manufacturing a first film material and
a control system for implementing a method according to claim 1.

19. The method according to claim 8,
wherein
an automatic modification in a material feed is carried out before the preparatory measure is implemented.

20. The method according to claim 12, wherein the process condition comprises at least the quality criterion of the first film material or a process stability criterion of the manufacturing process.
